(19) United States
(12) Patent Application Publication
(10) Pub. No.: US 2025/0300169 A1
(43) Pub. Date: Sep. 25, 2025

(54) LITHIUM IRON PHOSPHATE/CARBON/LITHIUM-RICH LITHIUM IRON OXIDE COMPOSITE CATHODE MATERIAL AND PREPARATION METHOD AND APPLICATION THEREOF

(71) Applicant: YINZHU (NINGBO) TECHNOLOGY LIMITED, Ningbo (CN)

(72) Inventor: Wenzhou LI, Ningbo (CN)

(73) Assignee: YINZHU (NINGBO) TECHNOLOGY LIMITED, Ningbo (CN)

(21) Appl. No.: 18/801,929

(22) Filed: Aug. 13, 2024

(30) Foreign Application Priority Data
Mar. 20, 2024 (CN) 202410325201.2

(51) Int. Cl. H01M 4/36; C04B 35/26; C04B 35/626; C04B 35/64; H01M 4/02; H01M 4/525; H01M 4/58; H01M 4/587

(52) U.S. Cl. CPC H01M 4/366; C04B 35/2691; C04B 35/62625; C04B 35/62655; C04B 35/62675; C04B 35/62695; C04B 35/64; H01M 4/525; H01M 4/5825; H01M 4/587; C04B 2235/3274; C04B 2235/422; C04B 2235/442; C04B 2235/447; C04B 2235/449; C04B 2235/48; C04B 2235/6562; C04B 2235/6567; H01M 2004/028

(57) ABSTRACT

A lithium iron phosphate/carbon/lithium-rich lithium iron oxide composite cathode material and a preparation method and an application thereof are provided. The preparation method includes the following steps: mixing iron salt, lithium compound, orthophosphate and an organic salt with water, to obtain a mixed slurry; performing a spray granulation on the mixed slurry, to obtain a precursor powder; and performing a heat preservation on the precursor powder in a protective atmosphere, to obtain a lithium iron phosphate/carbon/lithium-rich lithium iron oxide composite cathode material. The preparation method is based on the characteristics that electric double layer physical energy storage of porous carbon can enhance the rate, and lithium-rich lithium iron oxide additive can increase the system lithium source and prolong the service life, combined with the synthesis process of lithium iron phosphate and lithium-rich lithium iron oxide, a lithium iron phosphate/carbon/lithium-rich lithium iron oxide composite cathode material is synthesized by one-step method.

### CROSS REFERENCE TO THE RELATED APPLICATIONS

This application is based upon and claims priority to Chinese Patent Application No. 202410325201.2 filed on Mar. 20, 2024, the entire contents of which are incorporated herein by reference.

### TECHNICAL FIELD

The present disclosure relates to the technical field of cathode materials for lithium-ion batteries, and in particular, to a lithium iron phosphate/carbon/lithium-rich lithium iron oxide composite cathode material and its preparation method and application.

### BACKGROUND

Plug-in hybrid vehicles and vehicle start-stop power supplies are the terminal market of rate-type lithium iron phosphate cathode materials. However, the rate-type lithium iron phosphate cathode materials cannot take into account the long life characteristics at high rates, as a result, the service life of the battery is shorter. In order to meet the rate characteristic and cycle characteristic of lithium iron phosphate cathode materials, researchers usually use lithium iron phosphate nanocrystallization, carbon coating, porous carbon doping and other means. However, due to the high cost of the above scheme, it still cannot meet the actual needs of the rate and cycle characteristics of the rate-type lithium iron phosphate cathode material. With the continuous expansion of application fields, it is imperative to develop low-cost, high-rate, long-life lithium iron phosphate cathode materials.

### SUMMARY

The purpose of the present disclosure is to provide a lithium iron phosphate/carbon/lithium-rich lithium iron oxide composite cathode material and its preparation method and application, to solve the problem that the existing lithium iron phosphate cathode materials cannot meet the requirements of high rate, long cycle performance and high cost.

In order to achieve the above objective, the present disclosure adopts the following technical solutions:
the present disclosure provides a preparation method of a lithium iron phosphate/carbon/lithium-rich lithium iron oxide composite cathode material, including the following steps:
(1) mixing an iron salt, a lithium compound, orthophosphate and an organic salt with water, to obtain a mixed slurry;
(2) performing a spray granulation on the mixed slurry obtained in step (1), to obtain a precursor powder;
(3) performing a heat preservation on the precursor powder obtained in step (2) in a protective atmosphere, to obtain a lithium iron phosphate/carbon/lithium-rich lithium iron oxide composite cathode material;
wherein, in step (1), the organic salt is organic potassium salt or organic sodium salt; and
in step (3), a temperature of heat preservation is 500-700° C., a time is 6-12 h, and a heating rate is 1-5° C./min.

Preferably, in the preparation method of the lithium iron phosphate/carbon/lithium-rich lithium iron oxide composite cathode material, in step (1), the iron salt is one of ferric nitrate, ferric chloride, and iron carbonate, the lithium compound is one of lithium oxalate, lithium nitrate and lithium hydroxide, the orthophosphate is one of ammonium phosphate, ammonium hydrogen phosphate and ammonium dihydrogen phosphate, and the organic salt is alginate, humic acid salt or dodecyl benzene sulfonate.

Preferably, in the preparation method of the lithium iron phosphate/carbon/lithium-rich lithium iron oxide composite cathode material, in step (1), a molar ratio of the iron salt, the lithium compound and the orthophosphate is 2:6:1.

Preferably, in the preparation method of the lithium iron phosphate/carbon/lithium-rich lithium iron oxide composite cathode material, in step (1), a total mass ratio of the iron salt, the lithium compound and the orthophosphate to the organic salt is (95-97):(3-5).

Preferably, in the preparation method of the lithium iron phosphate/carbon/lithium-rich lithium iron oxide composite cathode material, in step (1), a concentration of iron salt in water is 3-8 mol/L.

Preferably, in the preparation method of the lithium iron phosphate/carbon/lithium-rich lithium iron oxide composite cathode material, in step (1), a mixing time is 6-8 h, and a temperature is 50-80° C.

Preferably, in the preparation method of the lithium iron phosphate/carbon/lithium-rich lithium iron oxide composite cathode material, in step (2), in the process of spray granulation of the mixed slurry, performing a continuous dispersion treatment on the mixed slurry.

Preferably, in the preparation method of the lithium iron phosphate/carbon/lithium-rich lithium iron oxide composite cathode material, in step (2), the conditions of the spray granulation are: an inlet temperature is 120-165° C., an outlet temperature is 80-120° C., a pressure of a spray head is 0.2-0.4 MPa, an air flow rate is 80-110 m³/h, and an extraction rate of sampling is 10-25%.

The present disclosure further provides a lithium iron phosphate/carbon/lithium-rich lithium iron oxide composite cathode material prepared by the preparation method of the lithium iron phosphate/carbon/lithium-rich lithium iron oxide composite cathode material.

The present disclosure further provides an application of the lithium iron phosphate/carbon/lithium-rich lithium iron oxide composite cathode material in lithium-ion batteries.

According to the above technical solutions, compared with the prior art, the present disclosure has the following beneficial effects:

According to the present disclosure, the organic potassium or sodium salt is used as a carbon source, mixed with other raw materials, after being dried etc., to form a lithium iron phosphate/lithium-rich lithium iron oxide precursor, then the carbon source is decomposed and dehydrogenated by high-temperature carbonization, based on the principle of self-activation of carbon source at high temperature to form porous carbon, the in-situ generated carbon is uniformly coated on the surface of lithium iron phosphate and lithium-rich lithium iron oxide, moreover, in-situ carbon can inhibit the growth of particles and alleviate the agglomeration of particles. The degassed hydrogen plays a certain role in pore formation, combined with other precipitated gases, the specific surface area of the composite cathode material is effectively increased, so as to optimize the pore structure of the composite cathode material and obtain a lithium-rich composite cathode material with higher lithium content. The present disclosure is based on the characteristics that electric double layer physical energy storage of porous carbon can enhance the rate, and the characteristics that lithium-rich lithium iron oxide additive can increase the system lithium source and prolong the service life, combined with the synthesis process of lithium iron phosphate and lithium-rich lithium iron oxide, a porous lithium iron phosphate/carbon/lithium-rich lithium iron oxide composite cathode material with high rate and long life is synthesized by one-step method, which effectively expands the application field of lithium iron phosphate cathode materials.

### BRIEF DESCRIPTION OF THE DRAWINGS

In order to more clearly illustrate the embodiments of the present disclosure or technical solutions in the prior art, the accompanying drawings used in the embodiments or the prior art will now be described briefly.

FIG. 1 is a preparation flow chart of a lithium iron phosphate/carbon/lithium-rich lithium iron oxide composite cathode material;

FIG. 2 is a rate performance curve chart of the battery obtained by Application Example 1; and

FIG. 3 is a cycle performance curve chart of the battery obtained by Application Example 1.

### DETAILED DESCRIPTION OF THE EMBODIMENTS

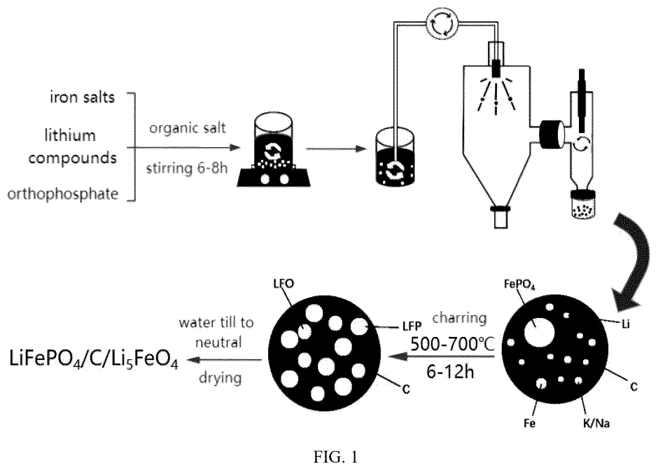

The present disclosure provides a preparation method of a lithium iron phosphate/carbon/lithium-rich lithium iron oxide composite cathode material, as shown in FIG. 1, including the following steps:
(1) mixing an iron salt, a lithium compound, orthophosphate and an organic salt with water, to obtain a mixed slurry;
(2) performing a spray granulation on the mixed slurry obtained in step (1), to obtain a precursor powder; and
(3) performing a heat preservation on the precursor powder obtained in step (2) in a protective atmosphere, to obtain a lithium iron phosphate/carbon/lithium-rich lithium iron oxide composite cathode material.

In the present disclosure, in step (1), the iron salt preferably includes one or more of ferric nitrate, ferric chloride, and iron carbonate, and further preferably ferric nitrate, ferric chloride, or iron carbonate, and more preferably ferric nitrate.

In the present disclosure, in step (1), the lithium compound preferably includes one or more of lithium oxalate, lithium nitrate, and lithium hydroxide, further preferably lithium oxalate, lithium nitrate, or lithium hydroxide, and more preferably lithium oxalate.

The reason why the present disclosure selects the above iron salt and lithium salt is that it is beneficial to the decomposition of nitrate and carbonate in a high-temperature condition or the conversion of chloride ion into hydrogen chloride in an acidic environment for release, and provides iron sources and lithium sources.

In the present disclosure, in step (1), the orthophosphate preferably includes one or more of ammonium phosphate, ammonium hydrogen phosphate, and ammonium dihydrogen phosphate, further preferably includes one or two of ammonium phosphate and ammonium hydrogen phosphate, and more preferably ammonium hydrogen phosphate.

In the present disclosure, in step (1), the organic salt is preferably alginate, humic acid salt or dodecyl benzene sulfonate, further preferably alginate or humic acid salt, and more preferably humic acid salt.

In the present disclosure, in step (1), the organic salt is preferably an organic potassium salt or an organic sodium salt, and further preferably an organic sodium salt.

The reason why the present disclosure disperses raw materials in water is that when water is used as a solvent to dissolve organic salts with high polarity, it has a higher solubility for organic salts and has a higher degree of dispersion in water, it is more conducive to the uniform mixing of raw materials and the movement of ions, it is conducive to the adsorption of lithium iron phosphate (LFP) and lithium-rich lithium iron oxide (LFO) into carbon channels, and meanwhile, it is also conducive to the adsorption of Li⁺ into carbon channels.

In the present disclosure, in step (1), a molar ratio of the iron salt, the lithium compound and the orthophosphate is preferably 2:6:1.

In the present disclosure, in step (1), a total mass ratio of the iron salt, the lithium compound and the orthophosphate to the organic salt is preferably (95-97):(3-5), further preferably (95-96):(4-5), and more preferably 95:5.

In the present disclosure, in step (1), a concentration of iron salt in water is preferably 3-8 mol/L, further preferably 4-6 mol/L, and more preferably 5 mol/L.

In the present disclosure, in step (1), the specific method of mixing iron salt, lithium compound, orthophosphate, organic salt and water is preferably as follows: adding iron salt, lithium compound and orthophosphate to water for dispersion, and then adding the organic salt for mixing.

In the present disclosure, in step (1), a mixing time is preferably 6-8 h, further preferably 6-7 h, and more preferably 6 h; and a temperature is preferably 50-80° C., further preferably 55-70° C., and more preferably 60° C.

In the present disclosure, in step (2), in the process of spray granulation of the mixed slurry, preferably performing a continuous dispersion treatment on the mixed slurry.

In the present disclosure, in step (2), the spray granulation device is preferably a spray dryer.

In the present disclosure, in step (2), the conditions of spray granulation are preferably: an inlet temperature is 120-165° C., an outlet temperature is 80-120° C., a pressure of a spray head is 0.2-0.4 MPa, an air flow rate is 80-110 m³/h, and an extraction rate of sampling is 10-25%; further preferably an inlet temperature is 125-150° C., an outlet temperature is 100-110° C., a pressure of a spray head is 0.2-0.3 MPa, an air flow rate is 90-100 m³/h, and an extraction rate of sampling is 15-25%; and more further an inlet temperature is 140° C., an outlet temperature is 110° C., a pressure of a spray head is 0.2 MPa, an air flow rate is 100 m³/h, and an extraction rate of sampling is 15%.

In the present disclosure, in step (3), the protective atmosphere is preferably nitrogen.

In the present disclosure, in step (3), the heat preservation device is preferably a tube furnace.

In the present disclosure, in step (3), a temperature of heat preservation is preferably 500-700° C., further preferably 600-700° C., and more preferably 700° C.; a time is preferably 6-12 h, further preferably 6-8 h, and more preferably 6 h; and a heating rate is preferably 1-5° C./min, further preferably 3-5° C./min, and more preferably 3° C./min.

In the present disclosure, in step (3), after heat preservation, it further preferably includes the following steps: cooling, washing and drying in turn.

The present disclosure does not limit the parameters of cooling, washing and drying, and the scheme well known to the technicians in this field can be used.

The present disclosure further provides a lithium iron phosphate/carbon/lithium-rich lithium iron oxide composite cathode material prepared by the preparation method.

In the present disclosure, a specific surface area of the lithium iron phosphate/carbon/lithium-rich lithium iron oxide composite cathode material is preferably 42-58 m²/g, further preferably 49-54 m²/g, and more preferably 49 m²/g.

The present disclosure further provides an application of the lithium iron phosphate/carbon/lithium-rich lithium iron oxide composite cathode material in lithium-ion batteries.

The present disclosure does not limit the method of the application, and the scheme known to the technical personnel in this field can be used. Specifically, in embodiments of the present disclosure, the lithium-ion battery preferably includes a positive electrode, a negative electrode, a separator film and an electrolyte. The positive electrode preferably includes a lithium iron phosphate/carbon/lithium-rich lithium iron oxide composite cathode material, a conductive agent and PVDF. The conductive agent is preferably carbon black, carbon nanotubes, conductive carbon fiber, graphene or acetylene black.

In the following, the technical solutions in the embodiments of the present disclosure will be clearly and completely described. Obviously, the described embodiments are only a part of the embodiments of the present disclosure, but not all the embodiments thereof. Based on the embodiments of the present disclosure, all other embodiments obtained by those skilled in the art without any creative efforts shall fall within the scope of the present disclosure.

### Embodiment 1

The present embodiment provides a preparation method of a lithium iron phosphate/carbon/lithium-rich lithium iron oxide composite cathode material, including the following steps:
(1) iron carbonate, lithium oxalate and ammonium phosphate were dispersed in water at a molar ratio of 2:6:1 (a concentration of iron carbonate was 3 mol/L), potassium alginate was added, a total mass ratio of iron carbonate, lithium oxalate and ammonium phosphate to potassium alginate was 95:5, stirring at 60° C. for 6 h, and a mixed slurry was obtained;
(2) the mixed slurry obtained in step (1) was continuously stirred, and the mixed slurry was performed a spray granulation by a spray dryer, the parameters were set as follows: an inlet temperature was 140° C., an outlet temperature was 110° C., a pressure of the spray was 0.2 MPa, an air flow was 100 m³/h, and an extraction rate of sampling was 15%, and a precursor powder was obtained; and
(3) the precursor powder obtained in step (2) was placed in a tube furnace, heated to 550° C. at a heating rate of 5° C./min under the protection of nitrogen, and kept at a temperature of 12 h, then cooled, and the product was washed to neutral and dried to obtain a lithium iron phosphate/carbon/lithium-rich lithium iron oxide composite cathode material with in-situ growth of carbon, and a specific surface area is 58 m²/g.

### Embodiment 2

The present embodiment provides a preparation method of a lithium iron phosphate/carbon/lithium-rich lithium iron oxide composite cathode material, including the following steps:
(1) ferric nitrate, lithium oxalate and ammonium hydrogen phosphate were dispersed in water at a molar ratio of 2:6:1 (a concentration of ferric nitrate was 5 mol/L), sodium humate was added, a total mass ratio of ferric nitrate, lithium oxalate and ammonium hydrogen phosphate to sodium humate was 95:5, stirring at 50° C. for 8 h, and a mixed slurry was obtained;
(2) the mixed slurry obtained in step (1) was continuously stirred, and the mixed slurry was performed a spray granulation by a spray dryer, the parameters were set as follows: an inlet temperature was 120° C., an outlet temperature was 80° C., a pressure of the spray was 0.3 MPa, an air flow was 100 m³/h, and an extraction rate of sampling was 10%, and a precursor powder was obtained; and
(3) the precursor powder obtained in step (2) was placed in a tube furnace, heated to 600° C. at a heating rate of 3° C./min under the protection of nitrogen, and kept at a temperature of 8 h, then cooled, and the product was washed to neutral and dried to obtain a lithium iron phosphate/carbon/lithium-rich lithium iron oxide composite cathode material with in-situ growth of carbon, and a specific surface area is 42 m²/g.

### Embodiment 3

The present embodiment provides a preparation method of a lithium iron phosphate/carbon/lithium-rich lithium iron oxide composite cathode material, including the following steps:
(1) ferric chloride, lithium hydroxide and ammonium phosphate were dispersed in water at a molar ratio of 2:6:1 (a concentration of ferric chloride was 4 mol/L), potassium humate was added, a total mass ratio of ferric chloride, lithium hydroxide and ammonium phosphate to potassium humate was 97:3, stirring at 80° C. for 6 h, and a mixed slurry was obtained;
(2) the mixed slurry obtained in step (1) was continuously stirred, and the mixed slurry was performed a spray granulation by a spray dryer, the parameters were set as follows: an inlet temperature was 140° C., an outlet temperature was 100° C., a pressure of the spray was 0.2 MPa, an air flow was 100 m³/h, and an extraction rate of sampling was 20%, and a precursor powder was obtained; and
(3) the precursor powder obtained in step (2) was placed in a tube furnace, heated to 650° C. at a heating rate of 5° C./min under the protection of nitrogen, and kept at a temperature of 12 h, then cooled, and the product was washed to neutral and dried to obtain a lithium iron phosphate/carbon/lithium-rich lithium iron oxide composite cathode material with in-situ growth of carbon, and a specific surface area is 54 m²/g.

### Embodiment 4

The present embodiment provides a preparation method of a lithium iron phosphate/carbon/lithium-rich lithium iron oxide composite cathode material, including the following steps:
(1) ferric nitrate, lithium oxalate and ammonium hydrogen phosphate were dispersed in water at a molar ratio of 2:6:1 (a concentration of ferric nitrate was 6 mol/L), sodium humate was added, a total mass ratio of ferric nitrate, lithium oxalate and ammonium hydrogen phosphate to sodium humate was 97:3, stirring at 60° C. for 8 h, and a mixed slurry was obtained;
(2) the mixed slurry obtained in step (1) was continuously stirred, and the mixed slurry was performed a spray granulation by a spray dryer, the parameters were set as follows: an inlet temperature was 150° C., an outlet temperature was 100° C., a pressure of the spray was 0.4 MPa, an air flow was 100 m³/h, and an extraction rate of sampling was 25%, and a precursor powder was obtained; and
(3) the precursor powder obtained in step (2) was placed in a tube furnace, heated to 700° C. at a heating rate of 3° C./min under the protection of nitrogen, and kept at a temperature of 6 h, then cooled, and the product was washed to neutral and dried to obtain a lithium iron phosphate/carbon/lithium-rich lithium iron oxide composite cathode material with in-situ growth of carbon, and a specific surface area is 49 m²/g.

### Embodiment 5

The present embodiment provides a preparation method of a lithium iron phosphate/carbon/lithium-rich lithium iron oxide composite cathode material, including the following steps:
(1) ferric nitrate, lithium nitrate and ammonium dihydrogen phosphate were dispersed in water at a molar ratio of 2:6:1 (a concentration of ferric nitrate was 5 mol/L), sodium humate was added, a total mass ratio of ferric nitrate, lithium nitrate and ammonium dihydrogen phosphate to sodium humate was 95:5, stirring at 55° C. for 6 h, and a mixed slurry was obtained;
(2) the mixed slurry obtained in step (1) was continuously stirred, and the mixed slurry was performed a spray granulation by a spray dryer, the parameters were set as follows: an inlet temperature was 125° C., an outlet temperature was 80° C., a pressure of the spray was 0.2 MPa, an air flow was 100 m³/h, and an extraction rate of sampling was 15%, and a precursor powder was obtained; and
(3) the precursor powder obtained in step (2) was placed in a tube furnace, heated to 500° C. at a heating rate of 1° C./min under the protection of nitrogen, and kept at a temperature of 8 h, then cooled, and the product was washed to neutral and dried to obtain a lithium iron phosphate/carbon/lithium-rich lithium iron oxide composite cathode material with in-situ growth of carbon, and a specific surface area is 51 m²/g.

### Contrast 1

The present contrast provides a preparation method for a lithium iron phosphate/carbon composite cathode material, including the following steps:
(1) iron carbonate, lithium oxalate and ammonium phosphate were dispersed in water at a molar ratio of 4:2:2 (a concentration of iron carbonate was 3 mol/L), potassium alginate was added, a total mass ratio of iron carbonate, lithium oxalate and ammonium phosphate to potassium alginate was 95:5, stirring at 60° C. for 6 h, and a mixed slurry was obtained;
(2) the mixed slurry obtained in step (1) was continuously stirred, and the mixed slurry was performed a spray granulation by a spray dryer, the parameters were set as follows: an inlet temperature was 140° C., an outlet temperature was 110° C., a pressure of the spray was 0.2 MPa, an air flow was 100 m³/h, and an extraction rate of sampling was 15%, and a precursor powder was obtained; and
(3) the precursor powder obtained in step (2) was placed in a tube furnace, heated to 550° C. at a heating rate of 5° C./min under the protection of nitrogen, and kept at a temperature of 12 h, then cooled, and the product was washed to neutral and dried to obtain a lithium iron phosphate/carbon composite cathode material with in-situ growth of carbon, and a specific surface area is 49 m²/g.

### Application Example 1

The lithium iron phosphate/carbon/lithium-rich lithium iron oxide composite cathode material obtained in Embodiment 1, graphite and PVDF were added to NMP according to a mass ratio of 8:1:1 and mixed evenly, then coated on the aluminum foil, dried in vacuum, after compaction by a twin rollers machine, then punched into a circular pole piece, which was used as a positive electrode; lithium metal anode and PC separator film were used, and 1 mol/L LiPF₆/(EC+DMC+December, a volume ratio was 1:1:1) was used as an electrolyte, and a button-type half battery was assembled in a vacuum glove box.

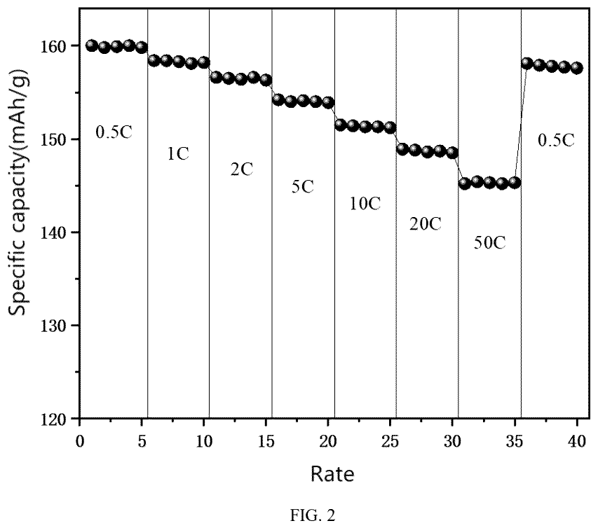

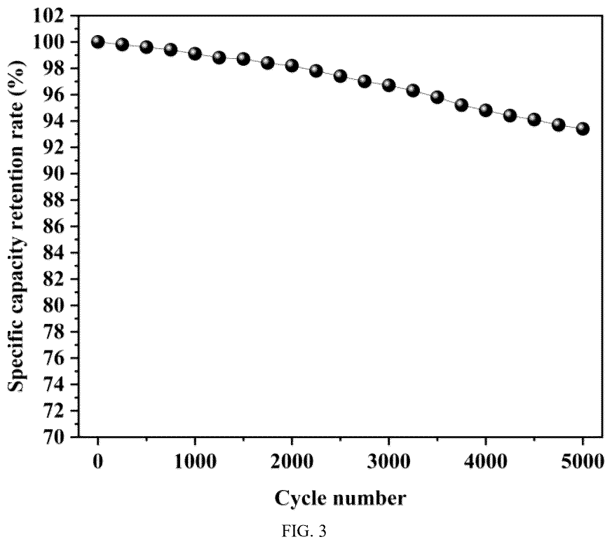

The button-type half battery prepared in Application Example 1 was charged and discharged at constant current, to test the rate performance and cycle performance. A range of the test voltage was 2.5-3.8V, a charge-discharge rate was 0.5C, 1C, 2C, 5C, 10C, 20C, 50C and 0.5C, and a rate performance curve was shown in FIG. 2. The results showed that a specific capacity of the battery obtained in Application Example 1 was 160.0 mAh/g, 158.4 mAh/g, 156.6 mAh/g, 154.2 mAh/g, 151.5 mAh/g, 148.9 mAh/g, 145.2 mAh/g and 157.8 mAh/g respectively when the charge-discharge rate was 0.5C, 1C, 2C, 5C, 10C, 20C, 50C and 0.5C, and a specific capacity retention rate was 90.75%. At 1 C, the charge-discharge cycle was 5000 times, and a cycle performance was shown in FIG. 3. The results showed that the specific capacity retention rate of the battery obtained in Application Example 1 was 93.4% when 5000 cycles at 1C.

### Application Example 2

The lithium iron phosphate/carbon/lithium-rich lithium iron oxide composite cathode material obtained in Embodiment 2, carbon black and PVDF were added to NMP according to a mass ratio of 8:1:1 and mixed evenly, then coated on the aluminum foil, dried in vacuum, after compaction by a twin rollers machine, then punched into a circular pole piece, which was used as a positive electrode; lithium metal anode and PC separator film were used, and 1 mol/L LiPF₆/(EC+DMC+December, a volume ratio was 1:1:1) was used as an electrolyte, and a button-type half battery was assembled in a vacuum glove box.

The button-type half battery prepared in Application Example 2 was charged and discharged at constant current, to test the rate performance and cycle performance. A range of the test voltage was 2.5-3.8V, a charge-discharge rate was 0.5C, 1C, 2C, 5C, 10C, 20C, 50C and 0.5C. The results showed that when the charge-discharge rate of the button-type half battery obtained in Application Example 2 was 0.5C and 50C, a specific capacity was 159.7 mAh/g and 144.5 mAh/g, respectively, and a specific capacity retention rate was 90.48%. At 1C, the charge-discharge cycle was 5000 times, and the specific capacity retention rate of the battery obtained in Application Example 2 was 91.7%.

### Application Example 3

The lithium iron phosphate/carbon/lithium-rich lithium iron oxide composite cathode material obtained in Embodiment 3, carbon black and PVDF were added to NMP according to a mass ratio of 8:1:1 and mixed evenly, then coated on the aluminum foil, dried in vacuum, after compaction by a twin rollers machine, then punched into a circular pole piece, which was used as a positive electrode; lithium metal anode and PC separator film were used, and 1 mol/L LiPF₆/(EC+DMC+December, a volume ratio was 1:1:1) was used as an electrolyte, and a button-type half battery was assembled in a vacuum glove box.

The button-type half battery prepared in Application Example 3 was charged and discharged at constant current, to test the rate performance and cycle performance. A range of the test voltage was 2.5-3.8V, a charge-discharge rate was 0.5C, 1C, 2C, 5C, 10C, 20C, 50C and 0.5C. The results showed that when the charge-discharge rate of the button-type half battery obtained in Application Example 3 was 0.5C and 50C, a specific capacity was 160.1 mAh/g and 145.7 mAh/g, respectively, and a specific capacity retention rate was 91.00%. At 1C, the charge-discharge cycle was 5000 times, and the specific capacity retention rate of the battery obtained by Application Example 3 was 92.3%.

### Application Example 4

The lithium iron phosphate/carbon/lithium-rich lithium iron oxide composite cathode material obtained in Embodiment 4, carbon black and PVDF were added to NMP according to a mass ratio of 8:1:1 and mixed evenly, then coated on the aluminum foil, dried in vacuum, after compaction by a twin rollers machine, then punched into a circular pole piece, which was used as a positive electrode; lithium metal anode and PC separator film were used, and 1 mol/L LiPF₆/(EC+DMC+December, a volume ratio was 1:1:1) was used as an electrolyte, and a button-type half battery was assembled in a vacuum glove box.

The button-type half battery prepared by Application Example 4 was charged and discharged at constant current, to test the rate performance and cycle performance. A range of the test voltage was 2.5-3.8V, a charge-discharge rate was 0.5C, 1C, 2C, 5C, 10C, 20C, 50C and 0.5C. The results showed that when the charge-discharge rate of the button-type half battery obtained in Application Example 4 was 0.5C and 50C, a specific capacity was 156.7 mAh/g and 143.5 mAh/g, respectively, and a specific capacity retention rate was 91.58%. At 1C, the charge-discharge cycle was 5000 times, and the specific capacity retention rate of the battery obtained by Application Example 4 was 92.1%.

### Application Example 5

The lithium iron phosphate/carbon/lithium-rich lithium iron oxide composite cathode material obtained in Embodiment 5, carbon black and PVDF were added to NMP according to a mass ratio of 8:1:1 and mixed evenly, then coated on the aluminum foil, dried in vacuum, after compaction by a twin rollers machine, then punched into a circular pole piece, which was used as a positive electrode; lithium metal anode and PC separator film were used, and 1 mol/L LiPF₆/(EC+DMC+December, a volume ratio was 1:1:1) was used as an electrolyte, and a button-type half battery was assembled in a vacuum glove box.

The button-type half battery prepared in Application Example 5 was charged and discharged at constant current, to test the rate performance and cycle performance. A range of the test voltage was 2.5-3.8V, a charge-discharge rate was 0.5C, 1C, 2C, 5C, 10C, 20C, 50C and 0.5C. The results showed that when the charge-discharge rate of the button-type half battery obtained in Application Example 5 was 0.5C and 50C, a specific capacity was 158.7 mAh/g and 143.7 mAh/g, respectively, and a specific capacity retention rate was 90.55%. At 1C, the charge-discharge cycle was 5000 times, and the specific capacity retention rate of the battery obtained in Application Example 5 was 90.2%.

### Contrast Application Example 1

The lithium iron phosphate/carbon composite cathode material obtained in Contrast 1, carbon black and PVDF were added to NMP according to a mass ratio of 8:1:1 and mixed evenly, then coated on the aluminum foil, dried in vacuum, after compaction by a twin rollers machine, then punched into a circular pole piece, which was used as a positive electrode; lithium metal anode and PC separator film were used, and 1 mol/L LiPF₆/(EC+DMC+December, a volume ratio was 1:1:1) was used as an electrolyte, and a button-type half battery was assembled in a vacuum glove box.

The button-type half battery prepared by Contrast Application Example 1 was charged and discharged at constant current, to test the rate performance and cycle performance. A range of the test voltage was 2.5-3.8V, a charge-discharge rate was 0.5C, 1C, 2C, 5C, 10C, 20C, 50C and 0.5C. The results showed that when the charge-discharge rate of the button-type half battery obtained in Contrast Application Example 1 was 0.5C and 50C, a specific capacity was 148.6 mAh/g and 128.5 mAh/g, respectively, and a specific capacity retention rate was 86.5%. At 1C, the charge-discharge cycle was 5000 times, and the specific capacity retention rate of the battery obtained in Contrast Application Example 1 was 78.3%.

The above description is only the preferred embodiments of the present disclosure. It should be pointed out that for ordinary technical personnel in this technical field, some improvements and embellishments can be made without departing from the principle of the present disclosure, which should also be regarded as the protection scope of the present disclosure.

What is claimed is:

1. A preparation method of a lithium iron phosphate/carbon/lithium-rich lithium iron oxide composite cathode material, comprising the following steps:
(1) mixing an iron salt, a lithium compound, orthophosphate, and an organic salt with water, to obtain a mixed slurry;
(2) performing a spray granulation on the mixed slurry obtained in the step (1), to obtain a precursor powder;
(3) performing a heat preservation on the precursor powder obtained in the step (2) in a protective atmosphere, to obtain the lithium iron phosphate/carbon/lithium-rich lithium iron oxide composite cathode material;
wherein, in the step (1), the organic salt is an organic potassium salt or an organic sodium salt; and
in the step (3), a temperature of the heat preservation is 500-700° C., a time is 6-12 h, and a heating rate is 1-5° C./min.

2. The preparation method according to claim 1, wherein in the step (1), the iron salt is one of ferric nitrate, ferric chloride, and iron carbonate, the lithium compound is one of lithium oxalate, lithium nitrate, and lithium hydroxide, the orthophosphate is one of ammonium phosphate, ammonium hydrogen phosphate, and ammonium dihydrogen phosphate, and the organic salt is alginate, humic acid salt, or dodecyl benzene sulfonate.

3. The preparation method according to claim 1, wherein in the step (1), a molar ratio of the iron salt, the lithium compound, and the orthophosphate is 2:6:1.

4. The preparation method according to claim 3, wherein in the step (1), a total mass ratio of the iron salt, the lithium compound, and the orthophosphate to the organic salt is (95-97):(3-5).

5. The preparation method according to claim 1, wherein in the step (1), a concentration of the iron salt in the water is 3-8 mol/L.

6. The preparation method according to claim 1, wherein in the step (1), a mixing time is 6-8 h, and a temperature is 50-80° C.

7. The preparation method according to claim 1, wherein in the step (2), in a process of the spray granulation of the mixed slurry, a continuous dispersion treatment is performed on the mixed slurry.

8. The preparation method according to claim 1, wherein in the step (2), conditions of the spray granulation are: an inlet temperature is 120-165° C., an outlet temperature is 80-120° C., a pressure of a spray head is 0.2-0.4 MPa, an air flow rate is 80-110 m³/h, and an extraction rate of sampling is 10-25%.

9. A lithium iron phosphate/carbon/lithium-rich lithium iron oxide composite cathode material prepared by the preparation method according to claim 1.

10. A method of applying the lithium iron phosphate/carbon/lithium-rich lithium iron oxide composite cathode material according to claim 9 in lithium-ion batteries.

11. The preparation method according to claim 2, wherein in the step (1), a molar ratio of the iron salt, the lithium compound, and the orthophosphate is 2:6:1.

12. The preparation method according to claim 7, wherein in the step (2), conditions of the spray granulation are: an inlet temperature is 120-165° C., an outlet temperature is 80-120° C., a pressure of a spray head is 0.2-0.4 MPa, an air flow rate is 80-110 m³/h, and an extraction rate of sampling is 10-25%.

13. The lithium iron phosphate/carbon/lithium-rich lithium iron oxide composite cathode material according to claim 9, wherein in the step (1) of the preparation method, the iron salt is one of ferric nitrate, ferric chloride, and iron carbonate, the lithium compound is one of lithium oxalate, lithium nitrate, and lithium hydroxide, the orthophosphate is one of ammonium phosphate, ammonium hydrogen phosphate, and ammonium dihydrogen phosphate, and the organic salt is alginate, humic acid salt, or dodecyl benzene sulfonate.

14. The lithium iron phosphate/carbon/lithium-rich lithium iron oxide composite cathode material according to claim 9, wherein in the step (1) of the preparation method, a molar ratio of the iron salt, the lithium compound, and the orthophosphate is 2:6:1.

15. The lithium iron phosphate/carbon/lithium-rich lithium iron oxide composite cathode material according to claim 14, wherein in the step (1) of the preparation method, a total mass ratio of the iron salt, the lithium compound, and the orthophosphate to the organic salt is (95-97):(3-5).

16. The lithium iron phosphate/carbon/lithium-rich lithium iron oxide composite cathode material according to claim 9, wherein in the step (1) of the preparation method, a concentration of the iron salt in the water is 3-8 mol/L.

17. The lithium iron phosphate/carbon/lithium-rich lithium iron oxide composite cathode material according to claim 9, wherein in the step (1) of the preparation method, a mixing time is 6-8 h, and a temperature is 50-80° C.

18. The lithium iron phosphate/carbon/lithium-rich lithium iron oxide composite cathode material according to claim 9, wherein in the step (2) of the preparation method, in a process of the spray granulation of the mixed slurry, a continuous dispersion treatment is performed on the mixed slurry.

19. The lithium iron phosphate/carbon/lithium-rich lithium iron oxide composite cathode material according to claim 9, wherein in the step (2) of the preparation method, conditions of the spray granulation are: an inlet temperature is 120-165° C., an outlet temperature is 80-120° C., a pressure of a spray head is 0.2-0.4 MPa, an air flow rate is 80-110 m³/h, and an extraction rate of sampling is 10-25%.

20. The preparation method according to claim 11, wherein in the step (1), a total mass ratio of the iron salt, the lithium compound, and the orthophosphate to the organic salt is (95-97):(3-5).
